(19) United States
(12) Patent Application Publication
(10) Pub. No.: US 2012/0115606 A1
(43) Pub. Date: May 10, 2012

(54) GAMING DEVICE AND METHOD INCORPORATING DEPICTION OF 3-D OBJECTS

(76) Inventor: Jerald C. Seelig, Galloway, NJ (US)

(21) Appl. No.: 13/293,998

(22) Filed: Nov. 10, 2011

Related U.S. Application Data
(60) Provisional application No. 61/412,284, filed on Nov. 10, 2010.

(51) Int. Cl. A63F 13/00

(52) U.S. Cl. 463/32

(57) ABSTRACT

A gaming device may comprise a display for displaying a game outcome. The display may depict a plurality of three-dimensional display objects, such as cubes, each having a number of display faces bearing gaming symbols. The game may comprise a number of turns. For each turn, the display objects are reoriented, for example by rotating the display objects about at least two axes, to display a set of surfaces of the display objects, e.g. the forward facing surfaces. Winning outcomes can be formed by matching symbols on adjacent display objects. The process of reorientation and display may continue for the number of turns of the game. Display surfaces that have been displayed in a turn may be indicated as ineligible for subsequent turns. The display objects can be transparent or translucent so that a player can see all gaming symbols on the display object.

### CROSS REFERENCE TO RELATED APPLICATIONS

This application claims priority to U.S. provisional patent application Ser. No. 61/412,284, filed Nov. 10, 2010, the contents of which is herein incorporated by reference.

### FIELD OF THE INVENTION

The present invention relates to gaming devices and to displays for gaming devices.

### BACKGROUND

Gaming devices such as slot machines are common in gaming establishments. The mechanism of playing a slot machine is well known. A player advances a wager in respect of a single gaming event. In modern slot machines, the single gaming event is typically the generation of a random number that is compared against a pay table to determine if the single gaming event produced a winning outcome. A winning outcome will pay a multiple of the wager with the multiple being dependent on the probability of that winning outcome.

Different slot machines generally have a similar look and feel. Therefore, in order for a gaming device to be successful, it is advantageous if that gaming device is easily understood and requires minimal learning by a player. In addition, gaming devices will tend to be more successful if they increase the excitement of playing a game. One way to increase excitement is by interaction with players that builds the excitement of the players, in particular, by allowing the player to anticipate outcomes.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide an attractive game display; and

the ability for a player to anticipate a potential game outcome.

These and other advantages may be realized by reference to the remaining portions of the specification, claims, and abstract.

### Brief Description of One Embodiment of the Present Invention

A gaming device may comprise a display for displaying a game outcome. The display may depict a plurality of three-dimensional display objects, such as cubes, each having a number of display faces bearing gaming symbols. The game may comprise a number of turns. For each turn, the display objects are reoriented, for example by rotating the display objects about at least two axes, to display a set of surfaces of the display objects, e.g. the forward facing surfaces. Winning outcomes may be formed by matching symbols on adjacent display objects. The process of reorientation and display may continue for the number of turns of the game. Display surfaces that have been displayed in a turn may be indicated as ineligible for subsequent turns. The display objects can be transparent or translucent so that a player can see all gaming symbols on the display object.

In one aspect, the invention provides a gaming system comprising a gaming device configured to receive a wager and play a game, a gaming device controller, a display device and a display device controller. The gaming device controller may be configured to determine a game outcome of the game. The display device controller may be configured to control a display on the display device to display the determined game outcome. The display device controller may be programmed to depict a plurality of three-dimensional display objects on the display device, the three-dimensional display objects comprising a plurality of display surfaces bearing gaming symbols and being rotatable such that each of the display surfaces of the display object can be displayed in one or more active surface positions of the display object. A first set of display surfaces of the plurality of display objects may be displayed in active surface positions of the respective display objects. A first award corresponding to the first set of display surfaces may be displayed and the plurality of display objects may be reoriented to display a second set of display surfaces of the plurality of display objects in the active surface positions of the respective display objects. A second award corresponding to the second set of display surfaces may be displayed.

In one aspect, the invention provides a method for displaying a game outcome on a display comprising a depiction of a plurality of three-dimensional display objects. Each 3-D object may have a plurality of display surfaces. In the method, the plurality of display objects may be displayed in a first orientation to display a first set of active surfaces. The set of active surfaces comprises one or more of the plurality of display surfaces of the plurality of objects and represents a first game outcome. An award that matches the first game outcome may be indicated and/or awarded to a player. The display objects may be re-oriented to a second orientation to display a second set of active surfaces that represent a second game outcome. An award that matches the second game outcome may then be indicated and/or awarded to the player.

The display may be controlled to represent a game outcome determined by a game controller in response to the player placing a wager and playing a game on a gaming device operatively associated with the display.

The display may display a game outcome of a primary game and/or a bonus game of a gaming device.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of a gaming system of the present invention;

FIG. 2 substantially illustrates a gaming system;

FIG. 3 substantially illustrates a bonus game display;

FIG. 4 substantially illustrates a 3-dimension display object in the form of a cube;

FIG. 5 substantially illustrates a depiction of a turn of a bonus game;

FIG. 6 substantially illustrates a cube with a grayed surface; and

FIG. 7 substantially depicts a method for displaying a game outcome.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

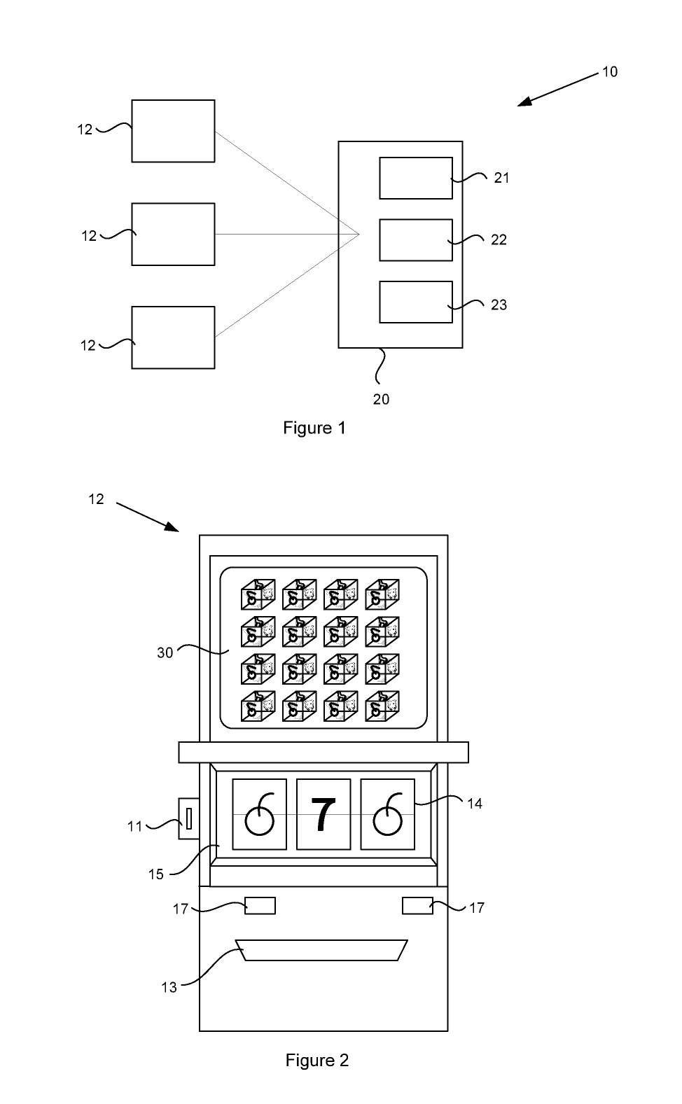

The present invention comprises a gaming system, generally indicated by reference number 10. The gaming system 10 includes one or more gaming devices 12, which may allow a player to place a wager and play a game. An example of a gaming device 12, shown in more detail in FIG. 2, includes a coin slot 11 for receiving wagers, such as coins or tokens, and a payout slot 13 through which winnings may be paid. The person skilled in the art will readily understand that the gaming device 12 is depicted schematically and many variants may be made. For example, the gaming device 12 may be configured to receive bills, casino tokens, credit cards or many other forms of payment. Similarly, winnings may be paid by tokens, tickets, credit or through other facilities of the gaming establishment.

With reference again to FIG. 1, the gaming devices 12 are operatively associated with a server 20, which may include components, such as a processor 21, memory 22 and random number generator 23. While the random number generator 23 is shown as a distinct component, the person skilled in the art will readily understand that the random number generator may be embodied within the processor 21. The server 20 may be provided within the vicinity of the gaming devices 12 or may be provided elsewhere in the gaming establishment and communicate with the gaming devices 12 through a communication link (not shown), as is known. The server 20 may operate as a game controller for primary and bonus games played on the gaming devices 12. Alternatively, game controllers may be provided within each of the gaming devices 12. In embodiments to be described, the game controllers may communicate game outcomes, including bonus game outcomes, to bonus game display controllers that cause a bonus game display to display a presentation that represents the determined bonus game outcome.

Each of the gaming devices 12 are configured to operate a game program that allows players to place wagers and play games. The server 20 may store game programs and information, which can be downloaded to the gaming devices 12 and gaming devices 12 may transmit information to the server 20. A gaming device 12 may offer a plurality of different games. When a player selects one of the games, the selected game may be downloaded from the server along with game related information, such as pay tables. Pay tables are used to determine the outcome of each game and they control the odds of winning a game and the amounts paid out. The gaming devices may be in one location, such as a casino, or they may be in different locations.

Referring to FIG. 2, in one embodiment, each gaming device 12 comprises a primary game, such as may be played in a known manner using video reels 14 provided on a primary game display area 15. The primary game may be played using control buttons 17, as is known. In addition to the primary game, the gaming device 12 may be configured with a secondary game provided as a bonus game. The bonus game may include a bonus game display 30.

The bonus game may be triggered by achieving a particular outcome in the primary game. For example, if the game controller, e.g. server 20, determines that a bonus game is to be awarded, the game controller can cause one or more particular bonus game symbols to be displayed on the primary game display 15. The base game display may automatically start the bonus game or prompt the player to commence play of the bonus game, e.g. by pressing a start button.

A particular embodiment of bonus game play will now be described, though a person skilled in the art will readily recognize that broader embodiments are conceivable within the scope of the present invention.

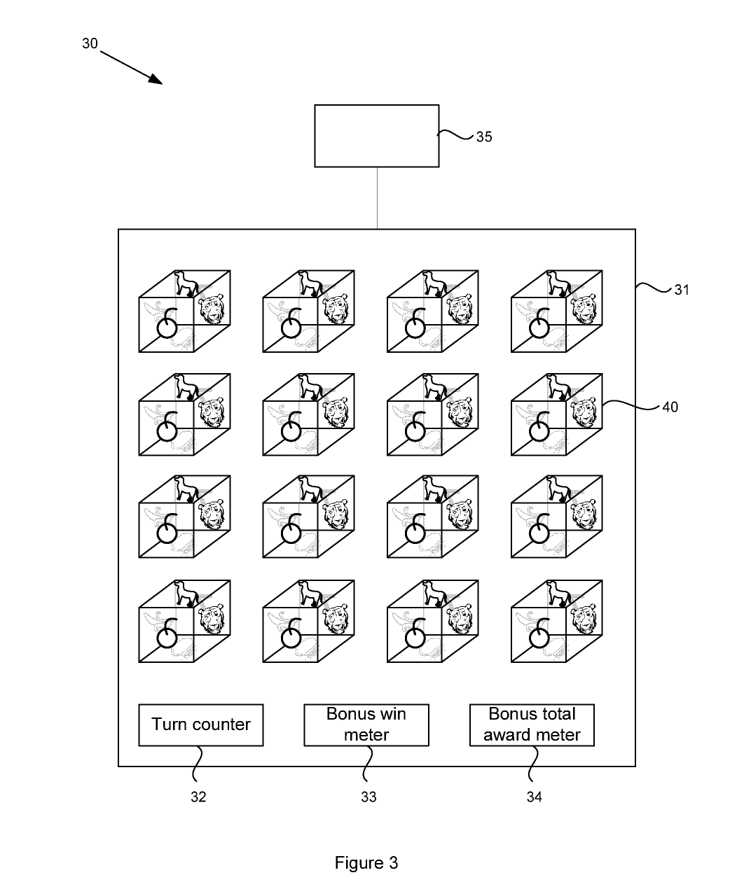

FIG. 3 depicts a bonus game display 30. The bonus game display may comprise a video screen 31, such as an LCD screen, though other screen types may also be used. A bonus game display controller 35 may be operatively coupled to the video screen 31 for controlling bonus game presentations made on the video screen 31. The bonus game display controller may be operatively associated with a game controller, such as the server 20 (FIG. 1) or a game controller internal to the particular gaming device with which the bonus game display 30 is associated. The display controller 35 may also be integrated with the game controller. The game controller may communicate game outcomes to the bonus game display controller 35, and the bonus game display controller 35 may react to cause the video screen 31 to depict a presentation that indicates the determined bonus game outcome, as will be described in greater detail below.

In the bonus game, a depiction of a 3-dimensional object 40 is used. Multiple display objects 40 may be depicted on the display 30 in individual display positions. In one embodiment, a 4×4 grid of display objects 40 is displayed. Each of the display objects 40 includes multiple display surfaces and is depicted in its display position as rotatable about multiple axes, as will be described in more detail below, so that each display surface of a display object may be presented to the player in an active surface position. The bonus game display 30 may further include a turn counter 32 that displays a number of turns of the bonus game that have been awarded and/or the number of turns remaining for the bonus game, bonus win meter 33 and a total bonus award meter 34.

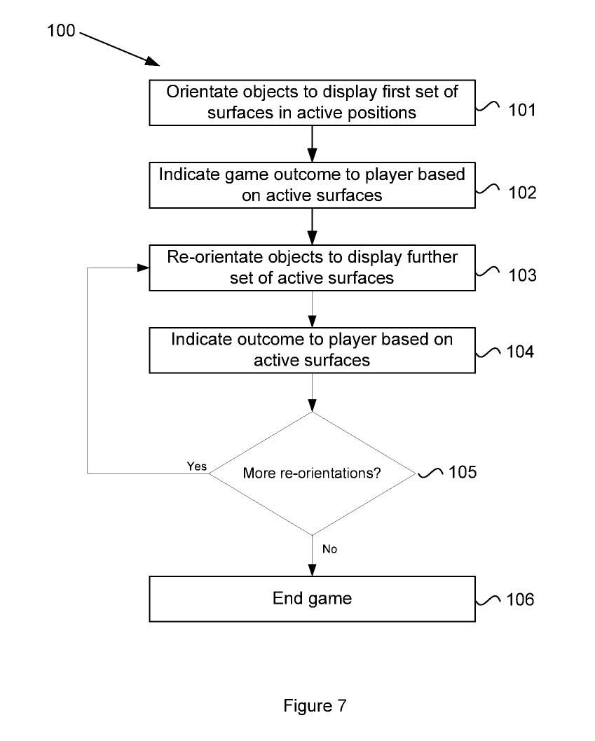

A method of playing the bonus game is depicted in the flowchart 100 of FIG. 7. At step 101, the display objects are displayed in a first orientation to display a first set display surfaces in active surface positions. For example, the most forward facing surface of a display surface may be the active surface position. At step 102, a first game outcome is indicated to the player based on the first set of active surfaces, for example, by indicating any symbols on the active surfaces that match adjacent symbols or match other symbols along a payline. In indicating a match, the win bonus meter 33 may also be updated. At step 103, the objects 40 are re-oriented, e.g. by rotating the objects vertically, horizontally or diagonally on their own axes, so that a second set of active surfaces are displayed. At step 104, a second game outcome is indicated to the player based on the second set of active surfaces. If there are more re-orientations to display (decision step 105), i.e. if there are more game cycles to play, then the process returns to step 103. Otherwise, the game ends 106. The objects may be re-oriented any number of times to indicate any number of game outcomes. In one embodiment, the player may be awarded a predetermined number of orientations. In one embodiment, the game may progress until each of the display surfaces of an object has been used as an active surface.

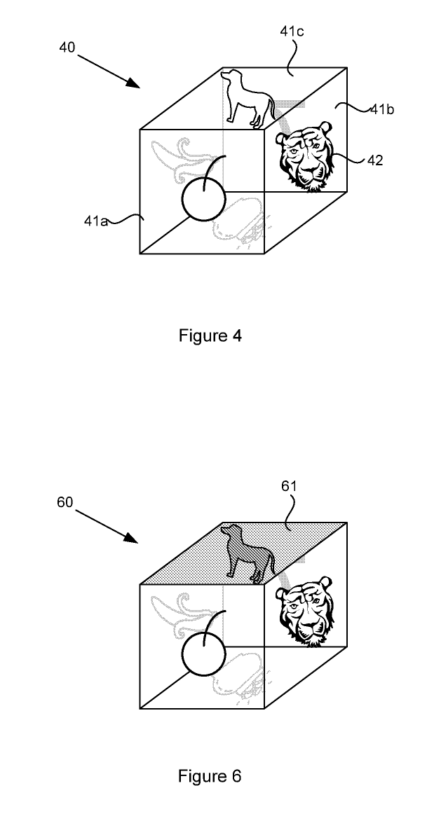

An example of a suitable 3-dimensional object is a cube, shown in FIG. 4. The cube 40 includes six display surfaces 41 of which a front surface 41a, right surface 41b and upper surface 41c are clearly visible to the player. On each display surface 41, there is shown a gaming symbol 42. The gaming symbols 42 may be unique to a display surface or the gaming symbols may be repeated across multiple display surfaces 41 of the cube 40. In the embodiment shown, each display surface 41 contains a unique gaming symbol 42. The cube 40 of FIG. 4 has gaming symbols of a Tiger, a Seven, a Banana, a Cherry, a Pot of Gold, and a Dog. Other gaming symbols will be apparent to a person skilled in the art. For example, the gaming symbols may relate to a common theme, such as being all fruit symbols, all animal symbols, all gem symbols, all card symbols, etc.

The object 40 may be depicted on the bonus game display to have one or more active surfaces. In one embodiment, the object 40 may have a single active surface which is the surface presented most towards the player, i.e. front surface 41a. In an alternative embodiment, there may be multiple active surfaces, such as any surface which is visible to the player, e.g. surfaces 41a, 41b, and 41c, as shown in FIG. 4.

The display surfaces of the object 40 may be substantially clear or translucent to enable the player to see all symbols on all display surfaces of the object, i.e. the active and non-active surfaces. For example, in the representation of the object 40 in FIG. 4, the lower surface bearing the Pot of Gold gaming symbol is notionally hidden and therefore is an inactive surface, yet the Pot of Gold symbol remains viewable to the player through the clear display surfaces 41a, 41b.

While the object 40 is depicted as a cube, other objects may be used. The objects may be regular n-sided figures having n-display surfaces, such as pyramids, polyhedrons, etc, each of which may bear a gaming symbol. In an alternative embodiment, the object may be an irregular object depicted three dimensionally, with a plurality of gaming symbols depicted thereon.

The display objects 40 may each include at least two axes of rotation so that all display surfaces of the display object can be brought into an active surface position. For example, a cube display object may have one vertical rotation axis and two orthogonal horizontal rotation axes. These multiple axes allow any display surface to be positioned as the most forward facing surface, corresponding to the active display surface.

When bonus game player is initiated, a bonus game controller randomly determines an outcome of the bonus game, including a bonus game award. The bonus game display controller 35 then controls the video screen 31 to present a depiction that conveys the bonus game outcome.

An embodiment of the bonus game presentation will now be described. As shown in FIG. 3, the bonus game display 30 displays sixteen 3-dimensional objects 40, which, in the presently described example, are cubes. Sixteen cubes are provided as an example and a person skilled in the art will recognize that other numbers and arrangements of the objects can be used. To “load” the game display, the sixteen cubes 40 may be depicted to randomly tumble from top to bottom and randomly stop. Play of the bonus game may comprise rotating some of all of the sixteen cubes to select an active display surface on the respective cube. When a cube stops, the display surface presented most towards the player is the active display surface and is used for indicating a game outcome.

Each display surface 41 of the cube has a gaming symbol or character that represents a different range of credit award values (e.g. 5-1000 Tiger, 5-1000 Cherry, 5-1000 Dog, 10-2000 Seven, 10-2000 Banana, 25-5000 Pot of Gold). When the cubes stop, any horizontal, vertical or diagonal adjacent cubes that have the same character on the active surface will make a match. Other arrangements can determine matches, such as symbols on a payline. In addition, a match can be made based on identical symbols, e.g. all Tigers, or a match may be made by completing a set of symbols. Other methods for determining matches will be apparent to a person skilled in the art. The award for each character match depends on how many characters are matched. For example, if two Tiger characters are matched, the award will be 5 for the match or if the characters were Pot of Gold symbols, the award would be 25. Ten or more matching Tiger characters would have an award of 1000 or if the symbols were Pot of Gold symbols, the award would be 5000, etc.

FIG. 5 depicts the active surfaces of the sixteen cubes. A particular arrangement of the cubes, as shown in FIG. 5, represents a “turn” or cycle of the bonus game. In this example, there are two horizontally matching Dog symbols 51, three horizontally and vertically matching Tiger symbols 52 and two diagonally matching Pot of Gold symbols 53. The award for each match is accumulated in the Bonus Win meter 33 during each turn and added to the Bonus Total Award meter 34 after each turn.

The bonus game play may include a plurality of turns or bonus game cycle. At each turn, the cubes are re-oriented, e.g., by rotating the objects vertically, horizontally, and/or diagonally, or any combination of these, about their own axes so that a different display surface is presented as the active surface. Alternatively, the objects may be re-oriented by re jumbling the objects on the display. The matches are then calculated and awards representing the matches are added to the bonus win meter. The re-orientation of the objects 40 may follow a re-orientation sequence, e.g. rotation about the horizontal axis, followed by rotation about the vertical axis, followed by rotation about an axis projecting out of the display. The rotations may be clockwise or counter-clockwise rotations. Each object may follow the same re-orientation sequence or different re-orientation sequences may be used for different objects. In one embodiment, the re-orientation of the objects may appear random to the player, i.e. one or more of the objects may follow a random re-orientation sequence. In an alternative embodiment, the re-orientation of one or more of the objects may follow a sequence that is predictable to a player.

A bonus game outcome may be determined for each turn within the bonus game. The display objects may then be rotated and reoriented to depict a newly determined game outcome for that turn. Alternatively, an aggregate bonus game outcome may be determined at the commencement of the bonus game and the display objects may follow a sequence of reorientations that is controlled so that the aggregate game outcome is displayed. For example, if at the beginning of the bonus game outcome, the aggregate bonus game outcome may correspond to an award of 100 credits. The display controller may then control the display of the display objects 40 so that, in multiple turns, the display objects depict one 50 credit outcome, three 10 credit outcomes and four 5 credit outcomes.

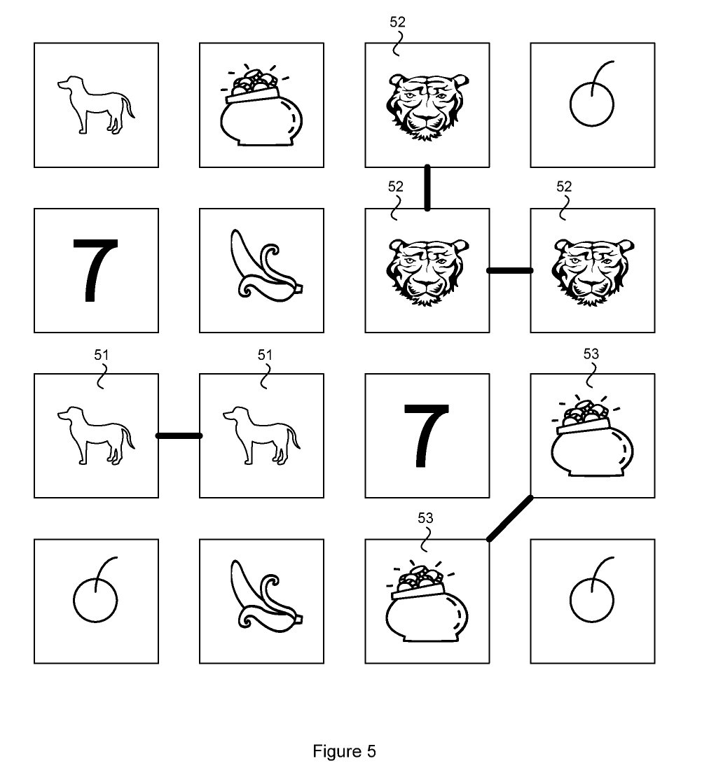

In one embodiment, after each re-orientation, the actively displayed side of the cube will be indicated and displayed as being ineligible for the remainder of the game, e.g. by graying the surface. An example of a grayed surface 61 is shown on the cube 60 of FIG. 6. In one embodiment, gray surfaces will not be presented as an active surface for the remainder of the bonus game. In one embodiment, grayed surfaces may be presented as active surfaces in subsequent turns but not used in the calculation of matches.

In one embodiment, the bonus game continues until all six sides of the cube become ineligible. That is, the maximum number of turns for the bonus game involving a cube as the object will be six. In a more general case, an n-sided figure will allow a maximum of n turns of the bonus game. After all turns are completed, the amount displayed by the Total Bonus Award meter 34 is awarded to the player, ending the bonus game.

As the display objects 40 have their surfaces increasingly de-activated, a player will be able to anticipate likely future matches remaining in the bonus game and will therefore be able to predict and anticipate potential game outcomes and winnings, therefore enhancing player excitement. This anticipation is enhanced by using display objects 40 which are clear or translucent so that a player is able to see which surfaces and symbols are still to be used as active surfaces. The effect can further be enhanced if a predictable and regular re-orientation sequence for re-orienting the display objects is used.

In one embodiment, the object 40 may include at least one “wild” symbol character that when it appears as an active surface next to another character (diagonal, left, right, top or bottom) will award the same credit value as that character.

In one embodiment, a player may be awarded a number of bonus game cycles or turns at the beginning of the bonus game. The number of turns awarded to a player may determine the display object that is displayed in the bonus game display. For example, if a player is awarded a bonus game with four bonus game cycles, a four sided object 40 may be displayed. If a player is awarded a bonus game with six bonus game cycles, a six sided object 40 may be displayed. That is, the number of display surfaces of the display object may be exactly equal to the determined number of turns of the game. Once a display surface has been actively displayed, it may be indicated as ineligible and is not displayed in the active display position for the remainder of the game. When the number of turns have been played, each of the display surfaces of the display object will have been used.

In an alternative embodiment, the display objects may be created so that the number of display surfaces is greater than or less than the determined number of turns.

The number of bonus game cycles of the game may be determined when the bonus game is awarded and may be determined randomly upon qualification to play the bonus game. Alternatively, the number of bonus game cycles of the game may be dependent on the qualification for the bonus game achieved in the primary or base game of the gaming device.

In one embodiment, each display object 40 may simultaneously display multiple active surfaces. For example, as shown in FIG. 3, the front, top and right surfaces may be considered to be active surfaces. Winning outcomes may be indicated by matching symbols on corresponding active surfaces. For example, two matching symbols on adjacent top surfaces may be considered a winning outcome. Alternatively, winning combinations may be indicated by matching symbols on non-corresponding active surfaces. That is, a winning combination may comprise a symbol on a top surface of a first display object and a matching symbol on a front surface of second display object that is adjacent the first display object.

Many modifications of the above specific embodiments within the scope of the present invention will be apparent to a person skilled in the art and all such modifications are intended to be encompassed herein. For example, while the bonus game display 30 depicts a regular 4×4 grid of display objects 40, a different number of objects 40 may be used and these objects may be arranged in various arrangements, provided that matches between objects can be clearly conveyed to a game player. In addition, many other types of 3-dimensional objects 40 will be readily conceivable.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A gaming system comprising:
(A) a gaming device configured to receive a wager and play a game;
(B) a gaming device controller configured to determine a game outcome of the game;
(C) a display device; and
(D) a display device controller configured to control a display on the display device to display the determined game outcome, wherein the display device controller is programmed to:
(a) depict a plurality of three-dimensional display objects on the display device, the three-dimensional display objects comprising a plurality of display surfaces bearing gaming symbols and being rotatable such that each of the display surfaces of the display object can be displayed in one or more active surface positions of the display object;
(b) display a first set of display surfaces of the plurality of display objects in active surface positions of the respective display objects;
(c) display a first award corresponding to the first set of display surfaces;
(d) reorient the plurality of display objects to display a second set of display surfaces of the plurality of display objects in the active surface positions of the respective display objects; and
(e) display a second award corresponding to the second set of display surfaces.

2. The gaming system of claim 1 wherein the plurality of display objects are depicted on the display device as being rotatable about at least two axes.

3. The gaming system of claim 2 wherein the display device controller is programmed to reorient at least one of the plurality of display objects by depicting rotation of the at least one display object about a first axis and depicting rotation of the at least one display object about a second axis.

4. The gaming system of claim 1 wherein each display of a set of display surfaces comprises a turn of the game.

5. The gaming system of claim 4 wherein a game outcome is determined for each turn.

6. The gaming system of claim 4 wherein an aggregate game outcome is determined for a plurality of turns, wherein the display device controller controls the display to depict a plurality of individual turn outcomes, and wherein an aggregate of the plurality of individual turn outcomes corresponds to the aggregate game outcome.

7. The gaming system of claim 4 wherein the game controller is configured to determine the number of turns of a game.

8. The gaming system of claim 7 wherein a game of the gaming device comprises a plurality of turns and wherein the display device controller controls the display device to depict reorientation of the plurality of display objects for each turn.

9. The gaming system of claim 7 wherein the display device controller is configured to display a display object comprising a number of faces that is equal to the determined number of turns of the game.

10. The gaming system of claim 4 wherein the display device controller is programmed to, after displaying a display surface in an active surface position, depict the displayed surface as an ineligible surface for subsequent turns of the game.

11. The gaming system of claim 10 wherein the display device controller controls the depiction of the display objects so that an ineligible display surface of a display object is not displayed in an active surface position.

12. The gaming system of claim 1 wherein the display device controller depicts one or more of the display objects as clear or translucent such that a player may view one or more gaming symbols on one or more of the display surfaces that are not in an active surface position.

13. The gaming system of claim 12 wherein the display device controller depicts one or more display surfaces of at least one display object as being behind a display surface of the at least one display object that is in the active surface position and wherein the display device controller depicts at least one gaming symbol on a display surface that is behind the display surface of the at least one display object that is in the active surface position.

14. The gaming system of claim 1 wherein the display objects comprise cubes.

15. A method for playing a wagering game comprising:
(A) receiving a wager at a gaming device;
(B) determining a game outcome in a game controller for the gaming device; and
(C) controlling a display device by a display device controller to display the game outcome, wherein displaying the game outcome comprises:
(a) displaying a plurality of three-dimensional display objects on the display device, the three-dimensional display objects comprising a plurality of display surfaces bearing gaming symbols and being rotatable such that each of the display surfaces of the display object can be displayed in one or more active surface positions of the display object;
(b) displaying a first set of display surfaces of the plurality of display objects in active surface positions of the respective display objects;
(c) displaying a first award corresponding to the first set of display surfaces;
(d) depicting reorientation of one or more of the plurality of display objects to display a second set of display surfaces of the plurality of display objects in the active surface positions of the respective display objects; and
(e) displaying a second award corresponding to the second set of display surfaces.

16. The method of claim 15 wherein depicting reorientation of one or more of the plurality of display objects comprises depicting rotation of at least one display object about at least two axes.

17. The method of claim 15 wherein a game of the game device comprises a plurality of turns, the method comprising determining the number of turns.

18. The method of claim 17 comprising:
(A) depicting reorientation of one or more of the plurality of display objects for each turn; and
(B) displaying an award corresponding to the reoriented display objects for each turn.

19. The method of claim 17 comprising determining a game outcome for each turn.

20. The method of claim 17 comprising:
(A) determining an aggregate game outcome for a plurality of turns; and
(B) controlling the display to depict a plurality of individual turn outcomes, wherein an aggregate of the plurality of individual turn outcomes corresponds to the aggregate game outcome.

21. The method of claim 17 wherein displaying a plurality of three-dimensional display objects on the display device comprises displaying display objects comprising a number of faces that is equal to the determined number of turns of the game.

22. The method of claim 17 comprising after displaying a display surface in an active surface position, depicting the displayed surface as an ineligible surface for subsequent turns of the game.

23. The method of claim 22 wherein an ineligible display surface of a display object is not displayed in an active surface position for subsequent turns of the game.

24. The method of claim 15 comprising displaying one or more of the display objects as clear or translucent such that a player may view one or more gaming symbols on one or more of the display surfaces that are not in an active surface position.

25. The method of claim 15 wherein the display objects comprise cubes.

26. A gaming apparatus comprising:
(A) gaming device means for receiving a wager and playing a game;
(B) gaming device controller means for determining a game outcome of the game;
(C) display means; and
(D) display controller means for controlling a display on the display device to display the determined game outcome comprising:
(a) displaying a plurality of three-dimensional display objects on the display means, the three-dimensional display objects comprising a plurality of display surfaces bearing gaming symbols and being rotatable such that each of the display surfaces of the display object can be displayed in one or more active surface positions of the display object;
(b) displaying a first set of display surfaces of the plurality of display objects in active surface positions of the respective display objects;
(c) displaying a first award corresponding to the first set of display surfaces;
(d) reorientating the plurality of display objects to display a second set of display surfaces of the plurality of display objects in the active surface positions of the respective display objects; and
(e) displaying a second award corresponding to the second set of display surfaces.

27. The gaming apparatus of claim 26 wherein the display controller means is configured to depict rotation of at least one display object about at least two axes.

28. The gaming apparatus of claim 26 wherein a game of the gaming device means comprises a plurality of turns, wherein each turn comprises a display of a set of surfaces of the plurality of display objects and wherein the display controller means controls the display means to reorient one or more of the display objects for each turn.

29. The gaming apparatus of claim 28 wherein the display controller means is configured to indicate a display surface displayed in the set of surfaces for a turn of the game as ineligible for subsequent turns of the game.
